(19) United States
(12) Patent Application Publication
(10) Pub. No.: US 2005/0008078 A1
(43) Pub. Date: Jan. 13, 2005

(54) Image display device, image display method, and recording medium on which image display program is recorded

(75) Inventor: Takashi Kurumisawa, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/857,000

(22) Filed: Jun. 1, 2004

(30) Foreign Application Priority Data
Jun. 24, 2003 (JP) 2003-179595

(51) Int. Cl. H04N 7/12

(52) U.S. Cl. 375/240.25; 375/240.27

(57) ABSTRACT

To provide an image display device having a liquid crystal panel or another display unit to display compressed video data including MPEG data, in which the display quality of the liquid crystal panel is enhanced without additional reference frame memory, an image display device that can be included in, for example, a mobile telephone and a PDA decodes compressed video data including MPEG data and displays them on a display panel, such as a liquid crystal panel. The image display device includes an LAO processing section, in which frame data to be displayed is corrected to enhance the display quality of the display panel. This correction is performed by changing the level of frame data based on a difference value, for example, between current frame data and previous frame data. This process in the LAO processing section and the decoding process of the compressed video data share a reference frame memory to reference the previous frame data, thus eliminating the need for an additional frame memory.

### BACKGROUND OF THE INVENTION

1. Field of Invention

The present invention relates to an image display device having a liquid crystal display panel or another image display unit, an image display method, and an image display program in which compressed video data are decoded into frame data and the frame data are corrected to enhance the display quality of the image display unit.

2. Description of Related Art

Generally, in the related art image data are compressed by encoding when they are digitized and stored in storage media. In particular, a moving picture image that has a large amount of data must be compressed to reduce the hardware load. For example, the Moving Picture Experts Group (MPEG) video coding international standard defines one image compression technology. Moving images encoded by this method can be played back with little quality degradation.

Japanese Unexamined Patent Application Publication No. 2001-296847 discloses an image processing technology in which images are encoded and decoded for playback by a method based on an orthogonal transformation, the discrete cosine transform (DCT), which is commonly used. An image display device disclosed in Japanese Unexamined Patent Application Publication No. 2001-296847 includes a digital signal processor (DSP) to decode MPEG data and a driver to control the display on a display panel based on data from the DSP. The DSP is connected to the driver via a signal line.

The DSP includes a variable length decoding section that decodes MPEG data with a variable length Huffman code, an inverse quantizing section that inverse-quantizes data from the variable length decoding section, and an inverse discrete cosine transform (IDCT) section that generates frame data by performing inverse discrete cosine transform on data from the inverse quantizing section. The frame data from the IDCT section are output to the driver via the signal line.

The driver includes an internal reference frame memory that stores the frame data from the DSP as reference frame data, a motion compensation section that motion-compensates frame data from the DSP with reference to the frame data in the reference frame memory, an RGB conversion section that color-converts frame data from the DSP or the motion compensation section, a display memory that stores frame data from the RGB conversion section as display data, and a display data output section that displays the display data in the display memory on a display panel.

As described above, when MPEG moving pictures are played back, frame data stored in the reference frame memory is referenced to generate images to be displayed.

Specifically, to decode and display moving pictures compressed with MPEG, the reference frame memory that temporarily stores image data of the previous frame is required for the motion compensation process.

In a liquid crystal panel, the slow response of the liquid crystal material disadvantageously degrades the display quality of motion pictures. To solve this problem, the Level Adaptive Overdrive (LAO) method is known. For example, Japanese Patent No. 3305240 discloses the LAO method to enhance the display quality of a liquid crystal display panel. In this patent, image differences between frames are emphasized to drive the liquid crystal display panel.

The LAO method has a step to calculate a difference between the current frame and the previous frame. Consequently, this method also requires a reference frame and therefore requires a frame memory.

M. Baba and H. Okumura, EURODISPLAY2002, pp. 155-158, October 2002 proposes a video playback system using the above-described LAO method to play back MPEG encoded video. In this system, decoding and overdriving of the MPEG data are processed in different blocks. Accordingly, both blocks have their own reference frame memories.

### SUMMARY OF THE INVENTION

As described above, decoding of MPEG compressed video data always requires a reference frame. The LAO process that enhances the display quality of a liquid crystal display panel also requires a reference frame when video is played back on the liquid crystal display panel. Therefore, when, as described in M. Baba and H. Okumura, EURODISPLAY2002, pp. 155-158, October 2002, MPEG data is decoded simultaneously with the LAO, which enhances the display quality of a liquid crystal display panel, an MPEG data decoding block and an LAO processing block require their own reference frame memories.

Recently, various types of multimedia data, such as audio and video, have been available via mobile terminals, including mobile telephones. For practical use, the mobile terminals must be low-power, compact, low-cost, and lightweight. However, it is difficult to provide a plurality of reference frame memories mainly due to cost limitations when the image display quality is enhanced using the LAO process in each mobile terminal that display MPEG video data on a liquid crystal display panel.

Accordingly, the present invention provides a low-power, compact, and low-cost image display device having a liquid crystal panel or another image display unit, an image display method, and an image display program by reducing the number of frame memories when compressed video data are decoded into frame data and the frame data are corrected to enhance the image quality displayed on the image display unit.

According to one aspect of the present invention, an image display device having an image display unit to display compressed video data includes an image decoding device to decode input compressed video data and generating frame data, a frame data storage unit to store the frame data generated by the image decoding device, a frame data correction device to correct the frame data by using preceding frame data stored in the frame storage unit, and a display device to display the corrected frame data on the image display unit, the image decoding device decoding the compressed moving picture data by using the preceding frame data stored in the frame data storage unit.

According to another aspect of the present invention, a method to display compressed moving picture data in an image display device having an image display unit includes image decoding to decode input compressed moving picture data and generating frame data, storing frame data generated in the image decoding into a frame data storage unit, correcting the frame data by using preceding frame data stored in the frame data storage unit, and displaying the corrected frame data on the image display unit, the image decoding decodes the compressed moving picture data by using the preceding frame data stored in the frame data storage unit.

According to another aspect of the present invention, an image display program executed in an image display device having an image display unit and a frame data storage unit to display compressed moving picture data, the image display device functioning as an image decoding device to decode input compressed moving picture data and generating frame data, a frame data storage device to store the frame data generated by the image decoding device into the frame data storage unit, a frame data correction device to correct the frame data by using preceding frame data stored in the frame data storage unit, and a display control device to display the corrected frame data on the image display unit. Herein, the image decoding device decodes the compressed moving picture data by using the preceding frame data stored in the frame data storage unit.

The above-described image display device, image display method, and image display program are suitably applied to mobile terminals, including mobile telephones, which display externally input compressed video data thereon. The compressed video data includes MPEG data. Input video data are decoded into frame data, which is stored in a frame data storage unit, such as a frame memory. The video data are compressed by using correlation of two temporally continuous frame images and are decoded by using preceding frame data stored in the frame data storage unit. Additionally, decoded frame data are corrected by, for example, the LAO process. The correction process also utilizes preceding frame data to display corrected frame data on the image display unit. Both the decoding process of the compressed video data and the correction process of the decoded frame data utilize the preceding frame data. Using the same frame data storage unit by both processes eliminates the need to provide them with their own frame data storage units, thus reducing the total cost of the device.

According to another aspect of the present invention, in the image display device, the frame data correction device corrects a level of the frame data to be corrected with a predetermined coefficient in accordance with a difference value between the frame data to be corrected and previous frame data. In liquid crystal display devices, the display quality of the moving picture image is enhanced by driving the liquid crystal display devices with the LAO process, in which data having a large difference between two continuous frame data are driven with large signal levels.

According to another aspect of the present invention, in the image display device, the display device displays the frame data at twice the frame rate of the compressed moving picture data by alternately outputting frame data corrected by the frame data correction device and uncorrected frame data. The display quality is further enhanced by increasing the frame rate of the image data to be displayed in addition to the correction by the above-described LAO process.

According to another aspect of the present invention, in the image display device, the frame data correction device corrects only a luminance component of the compressed moving picture data. Human vision is more sensitive to the luminance component than to color difference components. Accordingly, the display quality is significantly enhanced by correcting only the luminance component instead of correcting all components of frame data, thereby decreasing the load of the correction process and the total cost.

### BRIEF DESCRIPTION OF THE DRAWINGS

FIG. 1 is a schematic of an image display device according to a first exemplary embodiment;

FIG. 2 is a schematic for explaining MPEG compressed image data;

FIGS. 3a and 3b show schematics for explaining an overdrive process;

FIG. 4 is a schematic of an image display device according to a second exemplary embodiment; and

FIG. 5 is a schematic of an image display device according to a third exemplary embodiment.

### DETAILED DESCRIPTION OF EXEMPLARY EMBODIMENTS

Exemplary embodiments according to the present invention will now be described with reference to the accompanying drawings.

### First Exemplary Embodiment

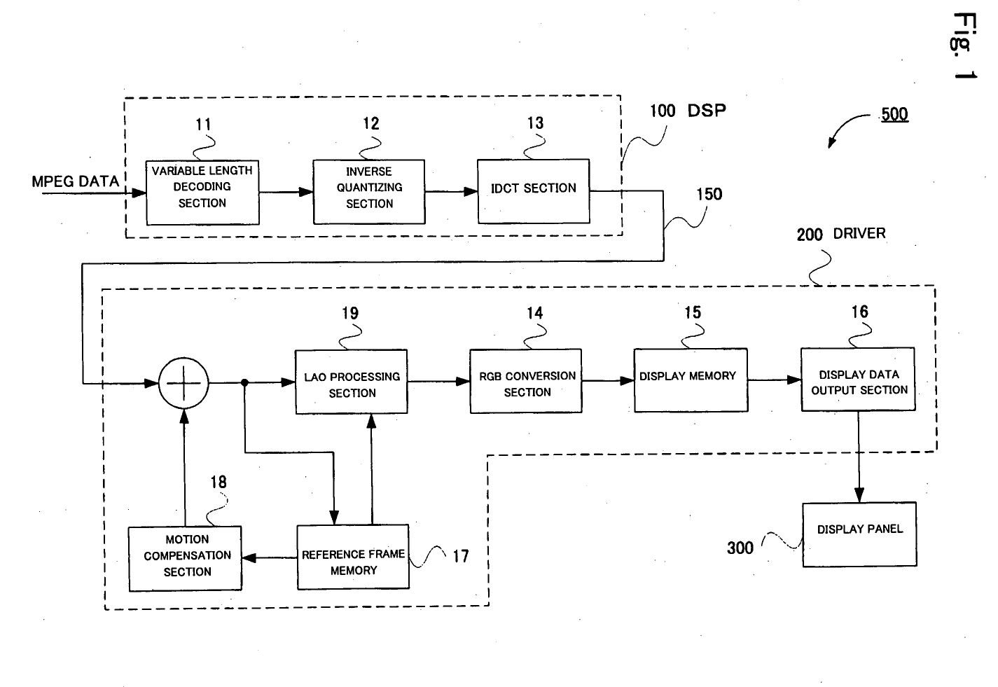

FIG. 1 shows a video playback unit according to a first exemplary embodiment of the present invention. In FIG. 1, an image display device according to the exemplary embodiment is applied to, for example, a mobile terminal that decodes MPEG compressed moving pictures to display video on a display panel. The mobile terminals include various terminals, such as a mobile telephone, a PDA, and a compact computer.

The structure of an image display device 500 according to the exemplary embodiment will now be described with reference to FIG. 1. FIG. 1 is a schematic of the image display device 500. Herein, MPEG data employ a coding format based on the known MPEG standard.

As shown in FIG. 1, the image display device 500 includes a digital signal processor (DSP) 100 that decodes MPEG data and a driver 200 that controls display of a display panel 300 based on the data from the DSP 100. The DSP 100 is connected to the driver 200 via a signal line 150. Input MPEG image data have a YUV format, in which Y is a luminance component, U is a color difference component of red, and V is a color difference component of blue.

First, data processing of the DSP 100 will be described. A variable length decoding section 11 decodes the MPEG data with a variable length Huffman code. An inverse quantizing section 12 then inverse quantizes data from the variable length decoding section 11. Subsequently, an inverse discrete cosine transform (IDCT) section 13 performs inverse discrete cosine transform on data from the inverse quantizing section 12 to generate frame data. The frame data from the IDCT section 13 are output to the driver 200 via the signal line 150.

Second, the process of the driver 200 will be described. The frame data from the DSP 100 is stored as reference frame data in a reference frame memory 17, which is an internal memory. A motion compensation section 18 then motion-compensates frame data from the DSP 100 with reference to the frame data in the reference frame memory 17 to generate frame data of the image to be displayed. In this exemplary embodiment, the driver 200 further includes a LAO processing section 19 that overdrives the frame data to enhance the display quality of the display panel 300. The overdrive process of the LAO processing section 19 is described in detail below. The frame data processed by the LAO processing section 19 is color-converted from YUV format to RGB format by an RGB conversion section 14. The frame data from the RGB conversion section 14 is stored in a display memory 15 as display data. The stored display data is then supplied to a display data output section 16 and is supplied to and displayed on the display panel 300.

Processes of the exemplary embodiment will now be described in detail.

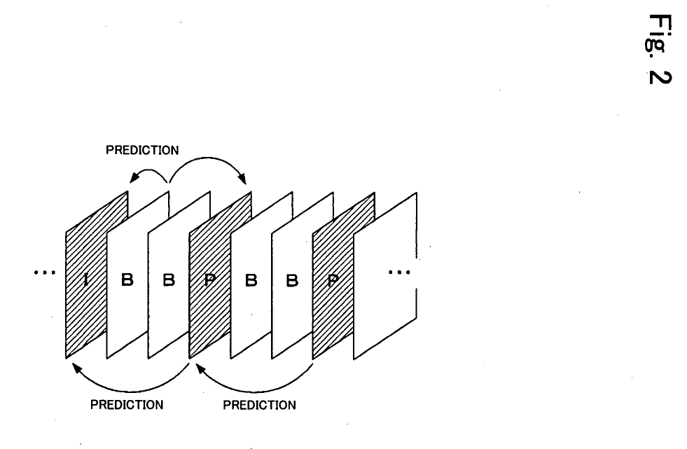

First, a process of the motion compensation section 18 is described. MPEG compressed video data includes the following three types of pictures: Intra-coded pictures (I pictures), Predictive-coded pictures (P pictures), and Bi-directionally predictive-coded pictures (B pictures). The types of image data and the decoding sequence will now be described with reference to FIG. 2. I pictures are data that is independently decodable into an image. P pictures are encoded difference data that is unidirectionally predicted from only a past frame. B pictures are encoded difference data that is bi-directionally predicted from both past and future frames. Thus, since MPEG data contain three different types of data, the image display unit 500 separately decodes each type of data, specifically, the I pictures, P pictures, and B pictures. In particular, the following processes are performed.

For the I pictures, the driver 200, upon receipt of frame data from the DSP 100, stores the input frame data in the reference frame memory 17 and outputs them to the LAO processing section 19.

For the P pictures, the motion compensation section 18 of the driver 200, upon receipt of frame data from the DSP 100, refers to the previous frame data in the reference frame memory 17 and adds a difference value of each block input from the IDCT section 13 and a pixel value of the block of the previous frame referred. The resulting value is stored in the reference frame memory 17 and is output to the LAO processing section 19.

For the B pictures, the motion compensation section 18 of the driver 200, upon receipt of frame data from the DSP 100, refers to the previous and future frame data in the reference frame memory 17 and adds a difference value of each block input from the IDCT section 13 and pixel values of the previous and future frames referred. The resulting value is output to the LAO processing section 19.

Second, the process of the LAO processing section 19 is described. In the LAO processing section 19, the LAO process is performed to enhance the display quality of moving pictures on a display panel, such as an LCD.

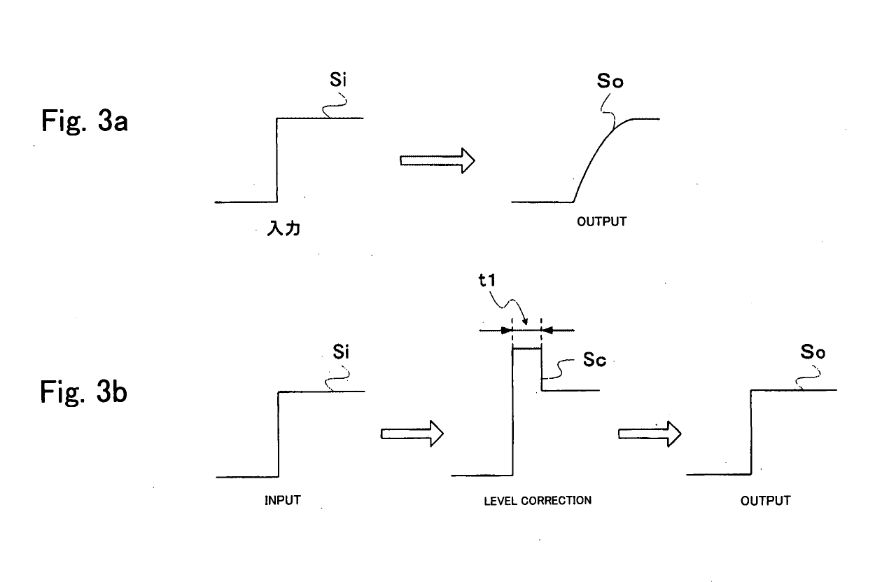

The above-described LAO process will now be described with reference to a particular case. Generally, in liquid crystal used for a liquid crystal display panel, changes in alignment of liquid crystal molecules lag behind changes in the electric field due to viscosity of the liquid crystal. For example, with reference to FIG. 3a, although an input signal Si having a steep level change drives a pixel of the liquid crystal display panel, a change in gray-scale of the pixel, which is shown as a signal So, is delayed due to a slow change in the alignment of liquid crystal molecules. Additionally, a signal change is also delayed at a falling time, although this is not shown.

To address this problem, the level of an input signal waveform applied to a driving circuit of the liquid crystal display panel is corrected to enhance the response time. Specifically, as shown in FIG. 3b, the level of the input signal Si is increased for a predetermined time period to generate a signal Sc, which drives the liquid crystal display panel. The signal Sc can enhance the response time of the liquid crystal display panel. The maximum level of the signal Sc is determined by the level of the input signal and the level of a signal as of a predetermined time before. For example, if an absolute value of the difference between the input signal level and the signal level as of a predetermined time before is large, the maximum level of the signal Sc is corrected to a large value. The level of the signal is increased during a time period t1, for example, one frame period.

Thus, the LAO process requires the signal level as of a predetermined time before. For this purpose, frame data in a reference frame memory is used.

In this exemplary embodiment, the above-described reference frame memory used for the overdrive process is shared with the MPEG data decoding process. The process of the LAO processing section 19 will be described in detail below.

The LAO processing section 19 performs a correction process based on frame data stored in the reference frame memory 17 (previous frame data) and frame data to be displayed from the motion compensation section 18 (current frame data). In particular, for example, in the correction process, a difference between the frame data stored in the reference frame memory 17 and frame data delivered from the motion compensation section 18 is multiplied by a predetermined coefficient. The resulting value is added to the frame data delivered from the motion compensation section 18. The coefficient is determined to be a large value if the absolute value of the difference is large. The frame data processed in the LAO processing section 19 as described above is delivered to the RGB conversion section 14, in which subsequent processes are carried out to display the data on the display panel 300.

Thus, the overdrive process in the LAO processing section 19 enhance the display quality of the moving pictures on the display panel 300. In this exemplary embodiment, the reference frame memory is shared by the overdrive process and the MPEG data decoding process. Consequently, the amount of frame memory required can be reduced.

### Second Exemplary Embodiment

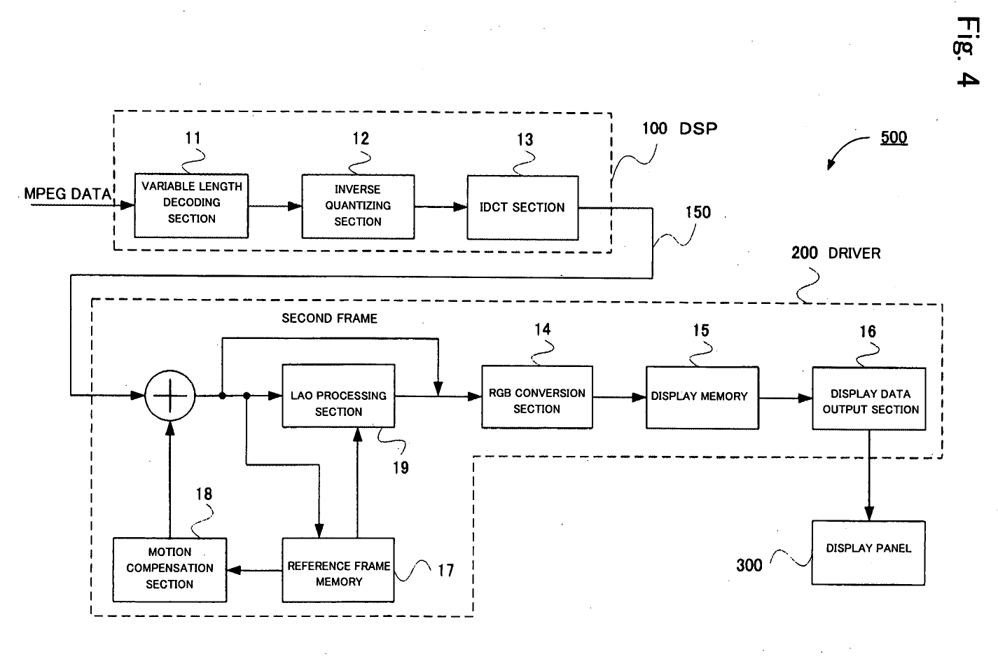

An image display device according to a second exemplary embodiment will now be described with reference to FIG. 4. In this exemplary embodiment, like the first exemplary embodiment, the LAO process enhances the image display quality. In addition, the display quality is further enhanced by increasing the frame rate of the moving pictures to be displayed. That is, after video data input to the image display device is decoded, the frame rate is, for example, doubled by interpolating frame data. In this case, the overdrive process is not performed for frame data displayed immediately after a displayed picture processed by a LAO processing section 19. The image display device according to the exemplary embodiment must be capable of displaying images at a frame rate twice that of the input video data. This process will be described with reference to the following particular case.

MPEG data processing in a DSP 100 is the same as that in the first exemplary embodiment. A variable length decoding section 11 decodes MPEG data with a variable length Huffman code. An inverse quantizing section 12 then inverse-quantizes data from the variable length decoding section 11. Subsequently, an IDCT section 13 performs inverse discrete cosine transform on data from the inverse quantizing section 12 to generate frame data. The frame data from the IDCT section 13 are output to a driver 200 via a signal line 150.

The process of the driver 200 will now be described. Like the first exemplary embodiment, the driver 200 includes the reference frame memory 17 to store frame data, a motion compensation section 18 for motion compensation, an LAO processing section 19 for the overdrive process, an RGB conversion section 14 to convert image data in YUV format to RGB format, a display memory 15 to store display data, and a display data output section 16. The output of the display data output section 16 is supplied to the display panel 300 and is displayed on the display panel 300, such as an LCD.

Herein, a video playback method and a data processing method according to the exemplary embodiment are described. Like the first exemplary embodiment, the LAO process in the LAO processing section 19 is performed for frame data delivered from the motion compensation section 18 to enhance the display quality of the display panel 300. Further, subsequent processes are performed to display the data on the display panel 300. In this exemplary embodiment, subsequently displayed frame data is not processed in the LAO processing section 19. In the LAO process, the level is changed in accordance with a difference value from the previous frame data. In this case, the same frame data is interpolated to double the frame rate. Accordingly, the interpolated frame data is the same as the preceding frame data and therefore the difference value is zero, thus eliminating the need for the LAO process.

In particular, for frame data next to the LAO process, the coefficient “0” may be multiplied by the difference value. That is, the image to be displayed next to the LAO process is the same as the preceding displayed image. For example, an odd frame is displayed after the LAO process is performed and an even frame the same as the preceding frame is displayed without the LAO process.

After the above-described processes, video is played back in which frames processed by the LAO are interpolated into original MPEG data. Additionally, the video is displayed at twice the frame rate of the input original MPEG data.

For example, a display device capable of displaying at a frame rate of 60 frames per second can play back MPEG data of 30 frames per second at a frame rate of 60 frames per second by using the above-described process.

Thus, in this exemplary embodiment, the frame rate of the display image is increased in addition to the LAO process. Accordingly, the video display quality is further enhanced.

### Third Exemplary Embodiment

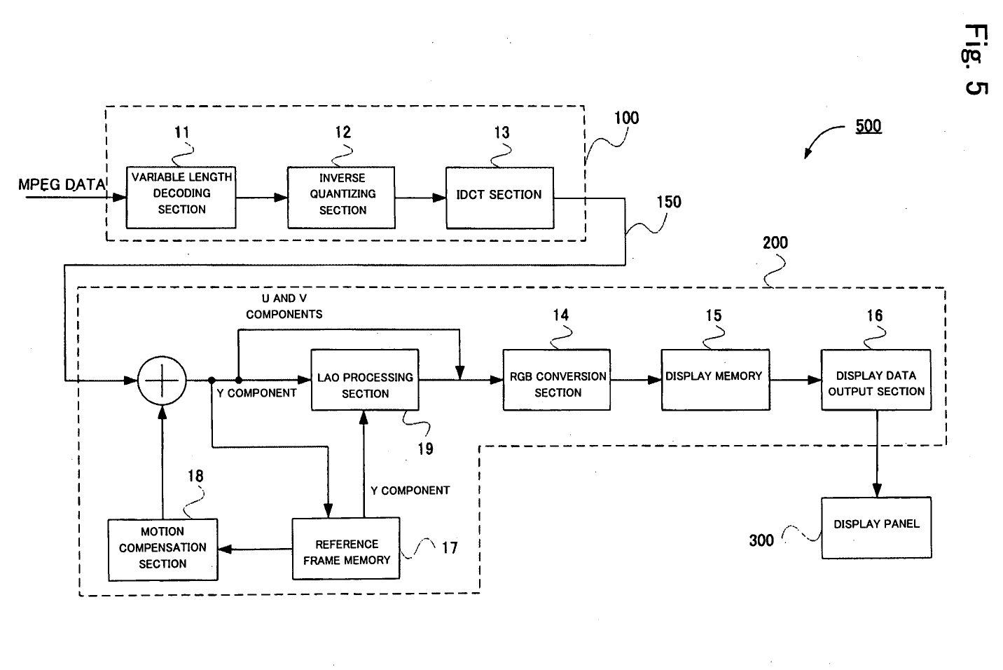

A third exemplary embodiment of the present invention will now be described. In the third exemplary embodiment, the process of the LAO processing section 19 is different from those in the first and second exemplary embodiments. FIG. 5 shows a display control unit to which an image display device according to the third exemplary embodiment is applied.

In the first and second exemplary embodiments, the LAO process is performed for all the Y, U, and V components of input image data in YUv format in the LAO processing section 19. In this exemplary embodiment, the LAO process is performed only for the Y component of input image data in YUV format, and not for the U and V components. Human vision is more sensitive to luminance (Y) than to color difference and hue space (U, V spaces) in terms of visual stimulation. Consequently, although the LAO process is applied to only the luminance (Y) component, the display quality is significantly enhanced for the human eye, thereby decreasing the amount of processing in the LAO processing section.

In particular, as shown in FIG. 5, only a Y component, which is one of the Y, U, and V components output from a motion compensation section 18, is input to an LAO processing section 19. The other components, the U and V components, are supplied to an RGB conversion section 14, bypassing the LAO processing section 19. Additionally, a difference value of only the Y components of successive frames is supplied from a reference frame memory 17 to the LAO processing section 19. Thus, the LAO process in the LAO processing section 19 is performed for only the Y component.

As described above, in the third exemplary embodiment, the amount of computation in the LAO processing section is decreased, thereby simplifying an arithmetic circuit therein and reducing the cost of the device.

1. An image display device having an image display unit to display compressed moving picture data, comprising:
an image decoding device to decode input compressed moving picture data and generate frame data;
a frame data storage unit to store the frame data generated by the image decoding device;
a frame data correction device to correct the frame data by using preceding frame data stored in the frame data storage unit; and
a display device to display the corrected frame data on the image display unit;
the image decoding device decoding the compressed moving picture data by using the preceding frame data stored in the frame data storage unit.

2. The image display device according to claim 1, the frame data correction device correcting a level of the frame data to be corrected with a predetermined coefficient in accordance with a difference value between the frame data to be corrected and previous frame data.

3. The image display device according to claim 2, the display device displaying the frame data on the image display unit at twice the frame rate of the compressed moving picture data by alternately outputting frame data corrected by the frame data correction device and uncorrected frame data.

4. The image display device according to claim 1, the frame data correction device correcting only a luminance component of the compressed moving picture data.

5. A method to display compressed moving picture data in an image display device having an image display unit, comprising:
decoding input compressed moving picture data and generating frame data;
storing the frame data generated in the image decoding step into a frame data storage unit;
correcting the frame data by using preceding frame data stored in the frame data storage unit; and
displaying the corrected frame data on the image display unit;
the image decoding decodes the compressed moving picture data by using the preceding frame data stored in the frame data storage unit.

6. A computer-readable recording medium on which an image display program is recorded, the image display program executed in an image display device having an image display unit and a frame data storage unit to display compressed moving picture data, the image display program comprising:
an image decoding program for decoding input compressed moving picture data and generating frame data;
a frame data storage program for storing the frame data generated by the image decoding program into the frame data storage unit;
a frame data correction program for correcting the frame data by using preceding frame data stored in the frame data storage unit; and
a display control program for displaying the corrected frame data on the image display unit;
the image decoding program decoding the compressed moving picture data by using the preceding frame data stored in the frame data storage unit.
